(19) United States
(12) Patent Application Publication
(10) Pub. No.: US 2024/0313197 A1
(43) Pub. Date: Sep. 19, 2024

(54) A secondary granulated silicon-carbon battery anode material and its preparation method thereof

(71) Applicant: LONG TIME TECH. CO., LTD., Taiwan (CN)

(72) Inventors: Xian-Cong Zhou, New Taipei City (TW); Yu-Shiang Wu, New Taipei City (TW); Hsu-Tien Hu, New Taipei City (TW); Po-Kun Chen, New Taipei City (TW); Lie-Kai Liu, Nan Chang City (CN)

(21) Appl. No.: 18/268,490

(22) PCT Filed: Jul. 21, 2021
(86) PCT No.: PCT/CN2021/107632

§ 371 Date: Jun. 20, 2023

(30) Foreign Application Priority Data
Dec. 21, 2020 (CN) 202011517597.9

(51) Int. Cl. H01M 4/36; C01B 32/21; H01M 4/587; H01M 4/62

(52) U.S. Cl. CPC H01M 4/366; C01B 32/21; H01M 4/587; H01M 4/622; C01P 2004/61; C01P 2006/11; C01P 2006/12; C01P 2006/40

(57) ABSTRACT

A secondary granulated silicon-carbon battery anode material and its preparation method is disclosed. The secondary granulated silicon-carbon battery anode material comprises a carbon substrate, a plurality of nano-silicon and a modified layer. According to the preparation method of the secondary granulated silicon-carbon battery anode material, the nano-silicon is embedded into the surface pores of the carbon substrate, and the modified layer is coated on them, so that the uniformity of the battery during size mixing and the liquid permeability of the anode material can be improved, and the effect of effectively improving the cycle performance and the stability of the battery can be further achieved.

### TECHNICAL FIELD OF THE INVENTION

The invention relates to a carbon base battery anode material, in particular to a secondary granulated silicon-carbon battery anode material and its preparation method thereof.

### BACKGROUND OF THE INVENTION

The development of new energy batteries depends to a large extent on the development and application of high-performance cathode and anode materials. Taking the anode material as an example, those skilled in the art have found that using the battery anode material formed through the granulation process can greatly improve the battery life and increase the charge and discharge times of the product. When natural or artificial graphite is used as the electrode material in the prior art, in order to reduce the initial irreversible capacity and improve the cycle life of the battery, it is usually necessary to first modify the surface with a pitch-substrate aromatic compound material.

The common anode granulation process in the conventional technology is to mix coke and pitch by high-temperature melting first, and then complete it through carbonization, graphitization and other procedures in sequence.

In order to further improve the performance of the anode material, silicon oxide is often added to graphite at the beginning of the process in the conventional art. FIG. 1 is a schematic diagram of an anode material for a carbon-substrate battery in the prior art. In the carbon-anode material 100, the added silicon oxide 140 can be adhered to the surface of the graphite 120 through the pitch 160, as shown in the FIG. 1. However, after the silicon oxide 140 is added, because the bonding force between the silicon oxide 140 and the graphite 120 is insufficient, the silicon oxide 140 falls off from the graphite 120 during the battery sizing, which will affect the uniformity of the battery sizing in subsequent applications. On the other hand, when the battery is charged and discharged, the volume change of the silicon oxide 140 will also cause the silicon oxide 140 to fall off from the surface of the graphite 120, thereby affecting the cycle stability of the battery. The above phenomenon will make the battery using the anode material of the prior art unable to exert its due performance.

In view of this, while effectively improving the performance of the battery anode material, it is necessary to develop a carbon battery anode material and its preparation method is a topic that deserves the attention of the industry and can effectively enhance the competitiveness of the industry.

### SUMMARY OF THE INVENTION

In view of the above background of the invention, in order to meet the requirements of the industry, the present invention provides a secondary granulated silicon-carbon battery anode material and its preparation method, the above secondary granulated silicon-carbon battery anode material and its preparation method not only have a simple manufacturing process, but also can greatly improve the uniformity of the battery slurry and the liquid seepage of the anode material. Furthermore, the secondary granulated silicon-carbon battery anode material and its preparation method can effectively improve the cycle stability of the battery, thereby effectively enhancing the effect of industrial competitiveness.

One objective of the present invention is to provide a secondary granulated silicon-carbon battery anode material and its preparation method, by embedding a plurality of nano-silicon in pores on surface of a carbon substrate to reduce the battery degradation due to nano-silicon falling off uniformity during mixing.

Another objective of the present invention is to provide a secondary granulated silicon-carbon battery anode material and its preparation method, by using a carbon substrate with its surface pores embedded with a plurality of nano-silicon for granulation to improve the liquid permeability during using battery.

Another objective of the present invention is to provide a secondary granulated silicon-carbon battery anode material and its preparation method. By using a modified layer to cover the carbon substrate with its surface pores embedded with the nano-silicon, the above secondary granulation of silicon-carbon battery anode material can further prevent nano-silicon from falling off from the carbon substrate, thereby reducing the uniformity of battery mixing due to the fall-off of nano-silicon and improving the liquid seepage during battery application.

Another object of the present invention is to provide a secondary granulated silicon-carbon battery anode material and its preparation method. By using a modified layer to cover the carbon substrate with nano-silicon embedded in surface pores of the carbon substrate, the secondary granulated silicon-carbon battery anode material can provide sufficient buffer capacity to cope with the volume change of nano-silicon due to charge and discharge during battery application, thereby achieving the effect of improving the cycle stability of the battery.

Yet another object of the present invention is to provide a method for preparing a secondary granulated silicon-carbon battery anode material. By using a rotary furnace that can change the temperature, the preparation method can complete secondary granulation in a rotary furnace, thereby achieving the effect of simplifying the manufacturing process.

According to the purpose, the present invention discloses a secondary granulated silicon-carbon battery anode material and its preparation method thereof. The secondary granulated silicon-carbon battery anode material comprises a carbon substrate, a plurality of nano-silicon, and a modified layer. The plurality of nano-silicon can be respectively embedded in the surface pores of the carbon substrate to form a carbon material with its surface pores embedded with the nano-silicon. In a preferred example, the plurality of nano-silicon can be respectively extruded and embedded in the surface pores of the carbon substrate to form the carbon material with its surface pores embedded with the nano-silicon. The modified layer can be coated on the carbon substrate with nano-silicon embedded in the surface pores. The preparation method of the secondary granulated silicon-carbon substrate battery anode material includes the steps of mixing nano-silicon and carbon substrate, adding binders, granulating and carbonizing, crushing, and sieving. In a preferred example, the above step of mixing nano-silicon and carbon substrate further includes a step of embedding nano-silicon into the carbon substrate by extrusion. In another preferred example, the granulating and carbonizing steps are completed in a rotary furnace. According to the technical proposal of this specification, the use of nano-silicon and the modified layer greatly improve the uniformity of the battery slurry and the liquid seepage of the anode material. Moreover, the secondary granulated silicon-carbon battery anode material and its preparation method thereof can effectively improve the cycle stability of the battery, thereby effectively enhancing the effect of industrial competitiveness.

### BRIEF DESCRIPTION OF THE DRAWINGS

FIG. 1 is a schematic diagram of an anode material for a carbon-substrate battery in the prior art;

FIG. 2A is a schematic diagram of a secondary granulated silicon-carbon battery anode material according to a first embodiment;

FIG. 2B is a schematic diagram of a secondary granulated silicon-carbon battery anode material according to a second embodiment;

FIG. 3 is a schematic diagram of a method for preparing a secondary granulated silicon-carbon battery anode material;

FIG. 4 is a comparison chart of the battery cycle test in which the silicon-carbon composite material obtained in the comparative examples 1-3 and example 1, where the X-axis is the number of cycle test cycles; the Y-axis is the specific capacity, and the unit is mAh/g; and

FIG. 5 is a comparison chart of the battery cycle test in which the silicon-carbon composite material obtained in comparative examples 1-3 and example 1; where the X-axis is the cycle number of test cycles; the Y-axis is the retention rate.

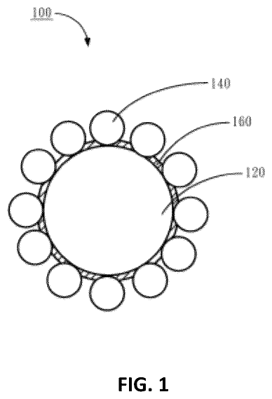

### BRIEF DESCRIPTION OF THE PREFERRED EMBODIMENTS

An embodiment of the present invention discloses a secondary granulated silicon-carbon battery anode material. The secondary granulated silicon-carbon battery anode material comprises a carbon substrate, a plurality of nano-silicon, and a modified layer. The plurality of nano-silicon can be respectively embedded into the surface pores of the carbon substrate to form a carbon material with its surface pores embedded with the nano-silicon. In a preferred example according to this embodiment, an external force can be used to extrude the plurality of nano-silicon into the surface pores of each carbon substrate to form the carbon material with its surface pores embedded with the nano-silicon. The modified layer can be coated on the carbon material with its surface pores embedded with the nano-silicon, so as to form the modified layer coating carbon material with its surface pores embedded the nano-silicon.

In a preferred example of this embodiment, a plurality of the modified layer coating carbon material with its surface pores embedded the nano-silicon can be stacked to form a carbon substrate assembly.

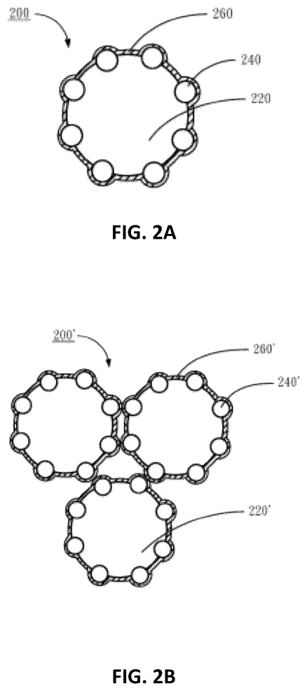

FIG. 2A is a schematic diagram of a secondary granulated silicon-carbon battery anode material according to a first embodiment. As shown in FIG. 2A, the secondary granulated silicon-carbon battery anode material 200 includes a carbon substrate 220, a plurality of nano-silicon 240, and a modified layer 260. In a preferred embodiment, the carbon substrate 220 may be selected from one of the following groups or a combination thereof: natural graphite, artificial graphite, graphene, carbon nanotubes (CNT), and gas phase growth carbon fiber (VGCF), mesophase carbon microsphere material (MCMB). In a preferred embodiment, the particle size of the carbon substrate 220 is about 5-20 μm. In another preferred embodiment, the particle diameter of the carbon substrate 220 is about 15 μm.

Refer to FIG. 2A, a plurality of nano-silicon 240 can be respectively embedded in the surface pores of the carbon substrate 220 to form a carbon material with its surface pores embedded with the nano-silicon. In a preferred embodiment, the plurality of nano-silicon 240 can be extruded and embedded in the surface pores of each carbon substrate 220 by an external force, so that the nano-silicon 240 can be extruded and embedded deeper into the surface of the carbon substrate 220 to form a carbon material with surface pores embedded with the nano-silicon. In a preferred embodiment, the particle size of the nano-silicon 240 is about 100-900 nm. In another preferred example, the particle size of the nano-silicon 240 is about 200 nm. The modified layer 260 is coated on the carbon substrate with surface pores embedded with the nano-silicon, so as to form a carbon material with surface pores embedded with the nano-silicon and coated with the modified layer. In a preferred example, the thickness of the modified layer 260 is about 15-1000 nm. In another preferred example, the thickness of the modified layer 260 is about 100 nm. The composition of the modified layer 260 may include an adhesive. In a preferred example, the binder may be selected from one of the following groups or a combination thereof: asphalt, phenolic resin, carboxymethyl cellulose (Carboxymethyl Cellulose, CMC for short), malt dextrin, styrene-butadiene rubber (Styrene-Butadiene Rubber, referred to as SBR)

FIG. 2B is a schematic diagram of a secondary granulated silicon-carbon battery anode material according to a second embodiment. As shown in FIG. 2B, the secondary granulated silicon-carbon battery anode material 200′ includes a plurality of carbon substrates 220′, a plurality of nano-silicon 240′, and a modified layer 260. According to this embodiment, the plurality of nano-silicon 240′ are respectively embedded in the surface pores of each carbon substrate 220′, so as to form a carbon substrate with surface pores embedded with nano-silicon. In a preferred example, an external force can be used to squeeze the plurality of nano-silicon 240′ into the surface pores of each carbon substrate 220′ to form the carbon material with its surface pores embedded with the nano-silicon.

In a preferred embodiment, the carbon substrate 220′ can be selected from one of the following groups or a combination thereof: natural graphite, artificial graphite, graphene, carbon nanotubes (CNT), and Vapor-grown carbon fiber (VGCF), meso-carbon microsphere material (MCMB). In a preferred example, the particle size of the carbon substrate 220′ is about 5-20 μm. In another preferred example, the particle size of the carbon substrate 220′ is about 15 μm. In a preferred example, the particle size of the nano-silicon 240′ is about 100-900 nm. In another example, the particle size of the nano-silicon 240′ is about 200 nm.

The modified layer 260′ can be coated on the carbon substrate with nano-silicon embedded in the surface pores, as shown in the FIG. 2B. In a preferred embodiment according to this example, a plurality of carbon substrates coated with a modified layer and embedded with nano-silicon in surface pores can be stacked to form a carbon substrate assembly, as shown in FIG. 2B. In a preferred example, the thickness of the modified layer 260′ is about 15-30 nm. In another preferred example, the thickness of the modified layer 260′ is about 20 nm. The modified layer 260′ includes an adhesive. In a preferred example, the binder may be selected from one of the following groups or a combination thereof: asphalt, phenolic resin, carboxymethyl cellulose (Carboxymethyl Cellulose, CMC for short), malt dextrin, styrene-butadiene rubber (Styrene-Butadiene Rubber, referred to as SBR).

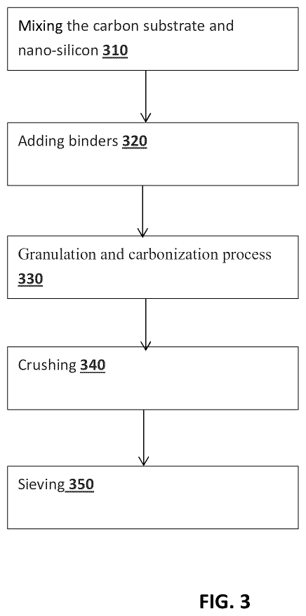

Another embodiment of the present invention discloses a method for preparing a secondary granulated silicon-carbon battery anode material. The FIG. 3 is a schematic diagram of a method for preparing a secondary granulated silicon-carbon battery anode material according to this embodiment. As shown in FIG. 3, the preparation method of the secondary granulated silicon-carbon substrate battery anode material includes the steps of mixing nano-silicon and carbon substrate, adding binder, granulation and carbonization, crushing, and sieving.

According to the preparation method of the secondary granulated silicon-carbon substrate battery anode material of this embodiment, the carbon substrate and nano-silicon are mixed first, so that the nano-silicon is respectively embedded in the surface pores of the carbon substrate to form a carbon material with its surface pores embedded with the nano-silicon, as shown in step 310. In a preferred example according to this embodiment, the above step 310 may further include a step of embedding the nano-silicon into the carbon substrate by extrusion. According to the present example, the plurality of nano-silicon are extruded and embedded deeper into the surface of the carbon substrate by extrusion by an external force, so as to form a carbon material with nano-silicon embedded in its surface pores. In a preferred example, the carbon substrate may be selected from one of the following or a combination thereof: natural graphite, artificial graphite, graphene, carbon nanotubes (CNT), and vapor-phase grown carbon fibers (VGCF), mesophase carbon microsphere material (MCMB). In a preferred example, the weight percentage of the nano-silicon is about 0.1-20 wt % of the carbon substrate. In a preferred example, the weight percentage of the nano-silicon is about 3-15 wt % of the carbon substrate. In a preferred example, the above step of mixing the carbon substrate and nano-silicon can be completed at room temperature (about 10-40° C.). In a preferred example, the particle size of the carbon substrate is about 5-20 μm. In another preferred embodiment according to this example, the particle size of the carbon substrate is about 15 μm. In a preferred example, the particle size of the nano-silicon is about 100-900 nm. In another preferred example, the particle size of the nano-silicon is about 200 nm.

In a preferred embodiment, the above step of mixing the carbon substrate and nano-silicon can be completed in a mixer with extrusion force.

Next, a binder is added to the carbon material with nano-silicon embedded in its surface pores, as shown in step 320. After the adhesive is fully mixed with the carbon substrate with the nano-silicon embedded in surface pores, the temperature can be raised to enter the granulation and carbonization steps, as shown in step 330.

In a preferred embodiment, the binder may be selected from one of the following groups or a combination thereof: asphalt, phenolic resin, carboxymethyl cellulose (Carboxymethyl Cellulose, CMC for short), malt dextrin, styrene-butadiene rubber (Styrene-Butadiene Rubber, referred to as SBR). In a preferred example, step 320 may be performed at room temperature (about 10-40° C.). In a preferred example, the weight ratio of the binder is about 5-15 wt % of the carbon material with surface pores embedded with nano-silicon. In a preferred example, the weight ratio of the binder is about 5-10 wt % of the carbon material with surface pores embedded with the nano-silicon.

In a preferred embodiment, the step 320 may further include adding a solvent to the carbon substrate with nano-silicon embedded in the surface pores, wherein the solvent in the solution can be used in subsequent granulation and carbonization. Volatile during the step. The solvent may be selected from one or a combination of the following: water, alcohol. During the heating process of the granulation and carbonization step 330, the binder will melt and cover the carbon substrate with surface pores embedded with nano-silicon to form a modified layer coated with surface pores embedded with nano-silicon. In a preferred example, depending on the adhesive used, the formation temperature of the carbon substrate coated with surface pores embedded with nano-silicon can be completed between 20 and 350° C. In a preferred example, a plurality of carbon substrates coated with the modified layer and embedded with nano-silicon in the surface pores can be stacked to form a carbon substrate assembly. In a preferred example, the thickness of the modified layer is about 15-1000 nm. In another preferred example, the thickness of the modified layer is about 100 nm.

In a preferred example, the carbonization temperature is about 900-1100° C. In a preferred example, the granulation and carbonization process in step 330 can be completed in a rotary furnace, a tube furnace, a pusher furnace, a roller furnace, or a static heating furnace.

After the steps of granulation and carbonization, the carbonized carbon substrate coated with the modified layer and embedded with nano silicon in the surface pores can be disintegrated, as shown in step 340. In a preferred example, step 340 may crush or disintegrate the carbon substrate coated with the modified layer and embedded with nano-silicon in surface pores into a plurality of small particles. According to this embodiment, after the crushing or disintegrating step 340, a sieving step 350 may be performed on the disintegrated small particles. In a preferred example, the above step 350 can screen out particles with a D50 of about 10-30 μm. In a preferred example according to this embodiment, the above step 350 can screen out particles with a D50 of about 17-23 μm.

A preferred example according to this specification will be described below.

### Comparative Example 1

After mixing nano silicon powder (D50 about 300 nm), artificial graphite (D50 about 14-17 μm), and pitch (D50 about 2-5 μm) in a V-type mixer, transfer to a tube furnace middle. The added amount of the nano-silicon powder is about 3 wt % of the total weight of the artificial graphite and the nano-silicon powder. The added amount of the pitch is about 7 wt % of the total weight of the artificial graphite and the nano-silicon powder. Carbonization was carried out by heating to 1000° C. in a tube furnace. Under an inert atmosphere, the tube furnace was heated from room temperature to 1000° C.′ at a rate of 5° C./min and kept for 3 hours. Afterwards, the temperature in the tube furnace is lowered back to room temperature to obtain the silicon-carbon composite material.

### Comparative Example 2

Firstly, nano-silicon powder (D50 about 300 nm) and artificial graphite (D50 about 14-17 μm) were uniformly mixed in a V-type mixer. The added amount of the nano-silicon powder is about 3 wt % of the total weight of the artificial graphite and the nano-silicon powder. Then add asphalt (D50 about 2-5 μm) into the V-type mixer, mix the asphalt with the nano-silicon powder and artificial graphite, and then transfer to the tube furnace. The added amount of the pitch is about 7 wt % of the total weight of the artificial graphite and the nano-silicon powder. Under an inert atmosphere, the tube furnace was heated from room temperature to 1000° C. at a rate of 5° C./min and kept for 3 hours. Afterwards, the temperature in the tube furnace is lowered back to room temperature to obtain the silicon-carbon composite material

### Comparative Example 3

Firstly, nano-silicon powder (D50 about 300 nm) and artificial graphite (D50 about 14-17 μm) were uniformly mixed in a V-type mixer. The added amount of the nano-silicon powder is about 3 wt % of the total weight of the artificial graphite and the nano-silicon powder. Then add asphalt (D50 about 2-5 μm) into the V-type mixer, mix the asphalt with the above-mentioned nano, silicon powder and artificial graphite, and then transfer to the rotary kiln. The added amount of the pitch is about 7 wt % of the total weight of the artificial graphite and the nano-silicon powder. Under an inert atmosphere, the rotary furnace was heated from room temperature to 1000° C. at a rate of 5° C./min and kept for 3 hours. Afterwards, the temperature in the rotary furnace is lowered back to room temperature to obtain the silicon-carbon composite material.

### Example 1

24 First, mix nano-silicon powder (D50 about 300 nm) and artificial graphite (D50 about 14-17 μm) in a mixer with extrusion force, so that the nano-silicon powder is embedded in the artificial graphite. The added amount of the nano-silicon powder is about 3 wt % of the total weight of the artificial graphite and the nano-silicon powder. Then add asphalt (D50 about 2-5 μm) into the V-shaped mixer, mix the asphalt with the above-mentioned nano-silicon powder and artificial graphite, and then transfer to the rotary furnace. The added amount of the pitch is about 7 wt % of the total weight of the artificial graphite and the nano-silicon powder. Under an inert atmosphere, the rotary furnace was heated from room temperature to 1000° C. at a rate of 5° C./min and kept for 3 hours. Afterwards, the temperature in the rotary furnace is lowered back to room temperature to obtain the silicon-carbon composite material. In the silicon-carbon composite material obtained in Example 1, nano-silicon powder is extruded and embedded on the surface of artificial graphite, and a modified layer (pitch) is added to cover the artificial graphite with nano-silicon powder embedded in surface pores. Therefore, the silicon-carbon composite material obtained in Example 1 will not find the nano-silicon powder falling off from the artificial graphite. On the other hand, due to the coating of the modified layer, after the silicon-carbon composite material is applied to the battery, it will not be easy to crack or escape due to expansion during the charging and discharging process. The properties of the silicon-carbon composite materials prepared in Comparative Examples 1-3 and Example 1 above can be summarized in Table 1.

TABLE 1

| | | | | Specific | Tap | |
|---|---|---|---|---|---|---|
| | Particles size (μm) | | | surface | density | |
| | D10 | D50 | D90 | area(m²/g) | (g/cc) | Ash |
| Comparative | 5.260 | 18.32 | 42.04 | 1.61 | 1.05 | 5.7306 |
| example 1 | | | | | | |
| Comparative | 5.164 | 18.11 | 42.88 | 1.59 | 1.05 | 5.7954 |
| example 2 | | | | | | |
| Comparative | 5.361 | 18.13 | 42.33 | 1.53 | 1.05 | 5.7162 |
| example 3 | | | | | | |
| Example 1 | 5.020 | 18.25 | 42.44 | 1.34 | 1.06 | 5.8967 |

According to Table 1, the silicon-carbon composite materials obtained in Comparative Examples 1-3 and Example 1 have similar particle sizes after disintegration and sieving, the silicon-carbon composite materials obtained in Example 1 have the lowest specific surface area. It shows that according to the practice of Example 1, asphalt exerts the best coating effect on the silicon-carbon composite material, thereby reducing the surface porosity. Furthermore, it can also be found from Table 1 that in the silicon-carbon composite material obtained in Example 1, the oxidation residue of the silicon material, that is, the ash value is relatively high. The above ash value shows that after being extruded into graphite, silicon powder can exist more firmly on the graphite surface.

### Example 2: Coin Battery Test

The silicon-carbon composite materials obtained in Comparative Examples 1-3 and Example 1 above were used as anode materials, and were assembled into coin batteries for CR2032 coin semi-electric test. The assembly method of the above button battery and the test process of the CR2032 button half battery are briefly described as follows.

The silicon-carbon composite material, conductive agent, substrate binder, dispersant and solvent obtained in Comparative Examples 1-3 and Example 1 were stirred in a planetary mixer for 3 hours to obtain a uniformly mixed slurry. The above slurry was uniformly coated on the copper foil current collector with an automatic coating machine, and the coating thickness was about 200 μm. After air drying at 60° C. for 30 minutes, it was placed in a vacuum drying oven to be vacuum-dried at 120° C. for 12 hours to obtain a anode sheet. The substrate binder is styrene-butadiene rubber (SBR), the dispersant is sodium carboxymethyl cellulose (CMC), and the conductive agent is super carbon black (SP). The weight ratio of the above anode material, SP, CMC, and SBR is about anode material: SP:CMC:SBR=94.5:2:1.5:2. The electrolyte used in the button battery is IM LiPF6 [in EC:DMC:EMC (1:1:1 vol. %) with 3 wt. % FEC], the metal lithium sheet is used as the counter electrode, and the separator is made of polypropylene (PP) microporous membrane.

The finally obtained anode sheet was cut into pieces by a punching machine to obtain an electrode sheet with a diameter of 12 mm. The electrode sheets were then transferred to a super-purified glove box filled with argon gas for assembly of CR2032 coin half cells. The general operation process of CR2032 button half battery assembly is as follows. Place the electrode sheet in the center of the positive electrode shell, and drop the electrolyte on it to make the electrode sheet completely wet. Place the separator flatly on the pole piece, and then add the electrolyte dropwise to completely wet the separator. A lithium sheet was placed on the separator as a counter electrode. Place the above gaskets and materials on the lithium sheet in sequence so that they are in the center of the battery, and then buckle the anode case. Then use a packaging machine to perform pressure packaging to obtain a CR2032 button half-cell.

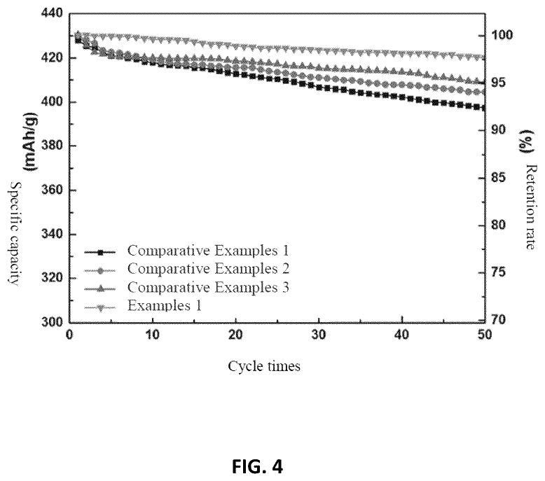

The CR2032 button half-cells packaged above can be put on hold for 12 hours before testing can begin. The CR2032 button half-battery can use the blue electric battery test system to perform a constant current charge-discharge cycle test on the battery with a current density of 0.1 C in the voltage range of 0.005-2.0V. The test results of 50 charge-discharge cycles are shown in the fourth figure. The FIG. 4 is a comparison chart of the battery cycle test in which the silicon-carbon composite material obtained in comparative examples 1-3 and example 1 is used as the anode material and subjected to 50 charge-discharge cycle tests according to this example. Among them, the X-axis is the number of cycle test cycles; the Y-axis is the specific capacity, and the unit is mAh/g.

It can be seen from FIG. 4 that the test result of Comparative Example 2 is better than that of Comparative Example 1. The above comparison shows that the operation method of mixing nano-silicon powder with artificial graphite can make nano-silicon powder evenly adhere to the surface of artificial graphite. The silicon-carbon composite material obtained by mixing nano-silicon powder and artificial graphite first, and then adding pitch, and then heating and carbonizing can exert better performance. At the same time, it can also be seen from the FIG. 4 that although the test results of the first ten laps of Comparative Example 3 are poor, the overall lap retention rate is better than that of Comparative Example 2. This is because silicon powder cannot be firmly present on the graphite surface only by ordinary mixing. Carrying out the carbonization process in a dynamic rotary kiln can obtain better asphalt coating and granulation effects, but because part of the silicon powder has been detached from the graphite and agglomerated, and the detached and agglomerated silicon powder caused the cycle performance to attenuate in the test fast. On the other hand, it can also be found from the FIG. 4 that the test result of Example 1 is far superior to that of Comparative Examples 1-3. That is to say, when mixing nano-silicon powder and artificial graphite, if the external force is applied to make the nano-silicon powder extruded and embedded on the surface of the artificial graphite, the obtained silicon-carbon composite material can be applied to the anode of the battery. Further improve the cycle performance of the battery.

The results of the battery cycle test of the silicon-carbon composite materials prepared in Comparative Examples 1-3 and Example 1 according to this example can be summarized in Table 2.

TABLE 2

| | specific | coulombic |
|---|---|---|
| | capacity (mAh/g.) | efficiency (%) |
| Comparative example 1 | 430.1 | 93.51 |
| Comparative example 2 | 430.5 | 93.72 |
| Comparative example 3 | 429.5 | 94.11 |
| Example 1 | 430.2 | 94.35 |

According to Table 2 that due to the addition of nano-silicon powder, the gram capacity of Comparative Examples 1-3 and Example 1 is significantly higher than that of graphite (the theoretical gram capacity of graphite is 372 mAh/g). Even better, the Coulombic efficiency of Example 1 is better than that of Comparative Examples 1-3.

### Example 3: Comparison of Battery Performance in Full Battery Test

The silicon-carbon composite material obtained in the above comparative examples and examples was used as the anode material, and assembled with the 523-type positive electrode ternary material to form a pouch battery for full battery testing. The assembly method of the above pouch battery and the testing process of the full battery are briefly described as follows.

Mix polyvinylidene fluoride (PVDF) and N-methyl-2-pyrrolidone (NMP) uniformly in a planetary mixer to make glue. Then, add super carbon black (SP) to the above glue and mix well to make conductive glue. Add positive electrode active material (523-type ternary material) into the above conductive glue, and stir in a planetary mixer for 4 hours to make it evenly mixed to prepare positive electrode slurry. Then adjust the viscosity of the positive electrode slurry to 8000±2000cp with NMP to obtain positive electrode slurry with good fluidity. Afterwards, the positive electrode slurry with good fluidity is evenly coated on both sides of the aluminum foil, and after drying, rolling, slitting, die-cutting and other processes, the positive electrode sheet can be obtained. Finally, put the positive electrode sheet into an oven for vacuum drying before use. Wherein, the weight ratio of the 523-type ternary material, conductive agent, and binder is about, 523-type ternary material:conductive agent:binder=95:2:3.

Mix CMC and distilled water on a planetary mixer to make glue. Then, add SP to the above glue and mix evenly to make the conductive glue. The anode materials (silicon-carbon composite materials) obtained in Comparative Examples 1-3 and Example 1 were respectively added to the conductive glue solution, and mixed uniformly to prepare anode slurry. Finally, distilled water was used to adjust the viscosity of the anode slurry to 2000±500cp, so as to obtain a anode slurry with good fluidity. The anode slurry with good fluidity is evenly coated on both sides of the copper foil, and after drying, rolling, slitting, die-cutting and other processes, the anode sheet can be obtained. Finally, put the anode sheet into an oven, and vacuum-dry it for use. Wherein, the weight ratio of the anode material. SP. CMC, and SBR is about, anode material: SP:CMC:SBR=94.5:2:1.5:2.

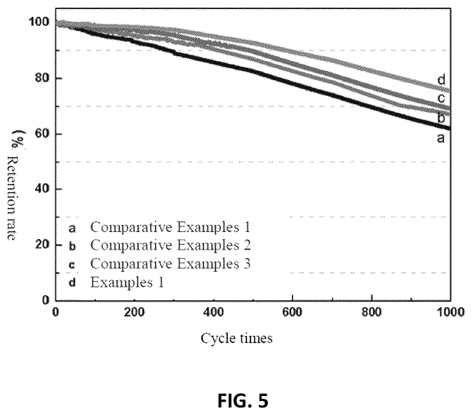

The aforementioned anode sheet, separator (polypropylene microporous membrane), and positive electrode sheet are loaded into a stacker for stacking to obtain a bare cell. The bare cells are encapsulated by aluminum-plastic film, and then after vacuum baking, liquid injection [IM LiPF6 in EC:DMC:EMC (1:1:1 vol. %) with 3 wt. % FEC], encapsulation, standing still and other steps, Lithium-ion secondary batteries can be obtained. The secondary battery can be charged at 0.5 C/discharged at IC, and the voltage range is 3.0V-4.2V. The energy density test can be performed at room temperature, and the cycle stability test can be performed at room temperature or 45° C. The results of the 1000-cycle charge-discharge cycle test of the full battery are shown in FIG. 5. The FIG. 5 is a comparison chart of the battery cycle test in which the silicon-carbon composite material obtained in comparative examples 1-3 and example 1 is used as the anode material according to the example for 1000 cycles of charge-discharge cycle test. Among them, the X-axis is the cycle number of test cycles: the Y-axis is the retention rate.

It can be seen from FIG. 5 that the test results of Example 1 are far superior to the button cells made of silicon-carbon composite materials obtained in Comparative Examples 1-3. After 1000 cycles of charging and discharging, the retention rates of Comparative Examples 1-2 all dropped significantly, while the retention rate of Comparative Example 3 was about 70%. Even better, after 1000 cycles of charging and discharging, the retention rate of Example 1 can still maintain about 80%.

In summary, this specification discloses a secondary granulated silicon-carbon battery anode material and a preparation method thereof. The secondary granulated silicon-carbon battery anode material includes a carbon substrate, a plurality of nano-silicon, and a modified layer. The plurality of nano-silicon can be respectively embedded in the surface pores of the carbon substrate to form a carbon material with its surface pores embedded with the nano-silicon. In a preferred example, the plurality of nano-silicon can be respectively extruded and embedded in the surface pores of the carbon substrate to form a carbon material with its surface pores embedded with the nano-silicon. The modified layer can be coated on the carbon substrate with nano-silicon embedded in the surface pores. In a preferred example, a plurality of carbon substrates coated with a modified layer and embedded with nano-silicon in surface pores can be stacked to form a carbon substrate set. The preparation method of the secondary granulated silicon-carbon battery anode structure includes the steps of mixing nano-silicon and carbon substrate, adding binder, granulating and carbonizing, crushing, and sieving. In a preferred example, the step of mixing the carbon substrate and nano-silicon further includes the step of extruding nano-silicon into the carbon substrate to form a carbon material with its surface pores embedded with nano-silicon. According to the technical proposal of this specification, the use of nano-silicon and the modified layer can greatly improve the uniformity of the battery slurry and the liquid seepage of the anode material. Compared with the existing silicon-carbon substrate material battery anode material and its preparation method, the battery anode material can effectively improve the cycle performance and stability of the battery, thereby effectively enhancing the effect of industrial competitiveness.

What is claimed is:

1. A secondary granulated silicon-carbon battery anode material, comprising
a carbon substrate;
a plurality of nano-silicon, wherein the plurality of nano-silicon is respectively embedded in surface pores of the carbon substrate to form a carbon material with its surface pores embedded with the nano-silicon; and
a modified layer, wherein the modified layer is coated on the carbon substrate and the nano-silicon, or wherein the modified layer is coated on the carbon material with its surface pores embedded with the nano-silicon.

2. The secondary granulated silicon-carbon battery anode material according to claim 1, wherein the nano-silicon is extruded and embedded in the surface pores of the carbon substrate.

3. The secondary granulated silicon-carbon battery anode material according to claim 1, wherein the carbon substrate is selected from the group consisting of: natural graphite, artificial graphite, graphene, carbon nanotubes (CNT), vapor grown carbon fibers (VGCF), meso-carbon microspheres (MCMB) and combinations thereof.

4. The secondary granulated silicon-carbon battery anode material according to claim 1, wherein the modified layer comprises a binder, and wherein the binder is selected from the group consisting of:
asphalt, phenolic resin and combinations thereof.

5. The secondary granulated silicon-carbon battery anode material according to claim 1, wherein the carbon material with its surface pores embedded with the nano-silicon is coated with the modified layers and further stacked to form a carbon substrate assembly.

6. A method for preparing a secondary granulated silicon-carbon battery anode material, comprising,
mixing a carbon substrate and nano-silicon to form a carbon material with its surface pores embedded with the nano-silicon;
adding a binder to the carbon material with its surface pores embedded with the nano-silicon to obtain a mixture;
granulating and carbonizing the mixture to form a plurality of modified layer coating carbon material with its surface pores embedded with the nano-silicon during heating, and to form a carbonized modified layer coating carbon material with its surface pores embedded with the nano-silicon after carbonizing;
crushing the carbonized modified layer coating carbon material with its surface pores embedded with the nano-silicon after carbonizing; and
sieving the carbonized modified layer coating carbon material with its surface pores embedded with the nano-silicon after crushing.

7. The method according to claim 6, wherein the mixing step of the carbon substrate and the nano-silicon further includes extruding and embedding the nano-silicon into the carbon substrate to form a carbon material with its surface pores embedded with the nano-silicon.

8. The method according to claim 6, weight percentage of the nano-silicon is 0.1-20 wt % of the carbon substrate.

9. The method according to claim 6, weight percentage of the binder is about 5-15 wt % of the carbon material with its surface pores embedded with the nano-silicon.

10. The method according to claim 6, wherein the granulating and carbonizing are completed in a rotary furnace.
